(19) United States
(12) Patent Application Publication
(10) Pub. No.: US 2021/0062482 A1
(43) Pub. Date: Mar. 4, 2021

(54) Shower apparatus

(71) Applicant: Runner (Xiamen) Corp., Xiamen (CN)

(72) Inventors: Bifu Dai, Xiamen (CN); Xinzhan Hu, Xiamen (CN); Wen Gao, Xiamen (CN)

(21) Appl. No.: 16/744,513

(22) Filed: Jan. 16, 2020

(30) Foreign Application Priority Data
Aug. 29, 2019 (CN) 201910807618.1

(51) Int. Cl. E03C 1/04; B05B 1/18

(52) U.S. Cl. CPC E03C 1/0408; E03C 1/0404; B05B 1/18

(57) ABSTRACT

Disclosed is a shower apparatus, including a water flow body having a water output device with a water outlet mounted thereon. The water flow body includes a first water flow conduit and a second water flow conduit. The water output device includes a switch device having a third water flow conduit communicating with the first water flow conduit and the water outlet. The switch device also includes a fourth flow conduit communicating with the second water flow conduit. The switch device can switch between at least two water output effects. The water flow body includes a control device for controlling the water input through the first water flow conduit or the second water flow conduit. The invention can change the relative position of the switch device by the impact of the waterflow, thereby changing the water output effect of the water outlet to ameliorate the showering experience.

### CROSS REFERENCE TO RELATED APPLICATION

The present application claims the priority of Chinese Application No. 201910807618.1, filed on Aug. 29, 2019.

### FIELD OF THE DISCLOSURE

The invention is related to a shower apparatus.

### BACKGROUND

With the elevation of living standard, people are accustomed to take shower with a versatile overhead showerhead. Nowadays the switch device for overhead showerhead is usually implemented by a wire-controlled switch device. Nonetheless the wire-controlled switch device has shown poor stability during the water transmission process. Alternatively, the contemporary shower apparatus may use a water-driven, remote-controlled switch device to control the overhead water spray. However, because such water-driven, remote-controlled switch device is built in a single water path architecture, waterflows be may mutually interfered during the water flow process and the switching process, which would in turn change the water spray pattern of the showerhead and deteriorate the water supply stability. Concretely speaking, when the user turns the faucet and opens the valve of the faucet, the switch device of the shower apparatus would be affected by the waterflow working thereon, so as to change the orifice of the water flow hole and affect the water spraying function, even if the user does not operate the switch device.

### SUMMARY

To address the aforesaid problems, an object of the invention is to provide a shower apparatus configured with dual water paths for switching the function of the showerhead by hydraulic drive, such that the supply water path for supplying water to the shower apparatus and the power water path for supplying power to the switch device will not be mutually affected, thereby ensuring the stability of the overhead water spray of the shower apparatus.

The invention is attained by the following technical solution:

A shower apparatus, including a water flow body, wherein the water flow body includes a water output device having a water outlet, and the water flow body is provided with a first water flow conduit and a second water flow conduit. The water output device is provided with a switch device inside, which includes a third water flow conduit communicating with the first water flow conduit and the water outlet. The switch device further includes a fourth water flow conduit communicating with the second water flow conduit. The switch device can be used to switch between at least two different water output effects. The water flow body further includes a control device for controlling the input water to be flowed in through the first water flow conduit or the second water flow conduit.

In the preferred embodiment of the invention, the control device includes a body having a water cutting body inside. The water cutting body is provided with a water input conduit, a first water output conduit, and a second water output conduit. The first water output conduit is communicated with the first water flow conduit. The second water output conduit is communicated with the second water flow conduit. The interior of the water cutting body is operatively connected to a water cutting shaft. A first spring is mounted between the water cutting shaft and the water cutting body.

In the preferred embodiment of the invention, the water cutting shaft is operatively connected to a pressing shaft. The pressing shaft is operatively connected to a switch.

In the preferred embodiment of the invention, the water flow body is further provided with a water input member. The water input member is provided with a fifth water flow conduit. The control device is provided with a water inlet communicating with the water input conduit.

In a first configuration the invention, the water input member is provided on the upper end of the water flow body. The interior of the water flow body is provided with a sixth water flow conduit having one end communicating with the fifth water flow conduit and the other end communicating with the water inlet.

In a second configuration of the invention, the water input member is provided on the lower end of the water flow body. The fifth water flow conduit is communicated with the water inlet on the control device.

In a first embodiment of the invention, the switch device includes a first body. The first body includes a first thrusting member, a first water bifurcation body, and a first water sealing cover. The first water bifurcation body is provided with ribs with a tilted surface. The first water bifurcation body is further provided with a first pressure discharging hole. A second spring is mounted between the first thrusting member and the first water bifurcation body. The first thrusting member is operatively connected to a first upper ratchet. The first upper ratchet is operatively connected to a first lower ratchet. The first lower ratchet is fixed on a first water bifurcation tray. The first water bifurcation tray includes a water flow hole providing at least two different functions. A third spring is mounted between the first water bifurcation tray and the first lower ratchet. More concretely, the water output device includes a first housing and a first water output cover. The first water output cover is provided with a third pressure discharging hole communicating with the first pressure discharging hole. The first housing is operatively connected to the first water output cover. A first water input body is mounted between the first housing and the first water output cover. The first water input body is operatively connected to first water bifurcation body. The first thrusting member and the second spring are disposed in a hollow chamber between the first water input body and the first water bifurcation body. The first water bifurcation body is provided with a water bifurcation opening. The first water bifurcation body is operatively connected to a first water bifurcation washer. The first water sealing cover is mounted on the first water output cover.

In a second embodiment of the invention, the switch device includes a second body. The second body includes a second thrusting member and a second water bifurcation body. A fourth spring is mounted between the second thrusting member and the second water bifurcation body. The second thrusting body is operatively connected to a pushing rod having one end provided with a tilted surface collaborating with the second thrusting member and the other end provided with a first teeth assembly. A fifth spring is telescoped on the pushing rod. The first teeth assembly is operatively connected to a lower chainring. The lower chainring is provided with a second teeth assembly engaged with the first teeth assembly. The lower chainring is further provided with a third teeth assembly. The third teeth assembly is operatively connected to a fourth teeth assembly. The fourth teeth assembly is mounted on an upper chainring. The upper chainring is operatively connected to the second water bifurcation tray. The second water bifurcation tray is provided with a sixth spring being compressed for position limiting. The upper chainring is also provided with a seventh spring being compressed. More concretely, the water output device includes a second housing and a second water output cover. The second housing is operatively connected to the second water output cover. A second water input body is mounted between the second housing and the second water output cover. The second water input body is operatively connected to the second water bifurcation body. The second thrusting member and the fourth spring are disposed in a hollow chamber between the second water input body and the second water bifurcation body. The second water bifurcation tray is operatively connected to a second water bifurcation washer. The second water bifurcation washer is mounted on a water bifurcation member. The water bifurcation member is operatively connected to a sealing member, which is provided with a second pressure discharging hole.

The shower apparatus of the invention is advantageous and beneficial in terms of the following effects:

1. The invention utilizes hydraulic power to switch the water output functions of the water output device, thereby overcoming the drawbacks lingered in the conventional wire-controlled switch device and enhancing the stability of water output.

2. The control device is mounted on the bottom of the water flow body for facilitating the user to operate the shower apparatus.

3. With the configuration of dual water paths, the invention can efficiently separate the supply water path for supplying water from the power water path for supplying power to the switch device, such that the supply water path will not interfere with the power water path. In this way, the stability of the water spray pattern of the water output device can be ensured. User can not affect the water spray pattern by opening or closing the faucet.

4. The invention uses only two conduits to provide the function for switching between at least two water spray patterns of the water output device.

5. The water input member can be mounted on the upper end or the lower end of the shower column, such that the invention is applicable to both the American-standard shower apparatus and the European-standard shower apparatus. Hence, the invention possesses better adaptability.

### BRIEF DESCRIPTION OF THE DRAWINGS

To illustrate the technological scheme embodying the embodiment of the invention more clearly, the accompanying drawings showing the embodiment of the invention or the conventional technology will be briefed in the following. Apparently, the accompanying drawings stated below are merely affiliated to some embodiments of the invention. An artisan having ordinary skill in the art can devise other drawings based on the accompanying drawings without exerting non-inventive laboring. In the figures:

FIG. 1 is an exploded view of the shower apparatus according to a first embodiment of the invention;

FIG. 2 is an exploded view of the shower apparatus according to a second embodiment of the invention;

FIG. 3 is a cross-sectional view of the shower apparatus according to a first embodiment of the invention;

FIG. 4 is a cross-sectional view of the shower apparatus according to a second embodiment of the invention;

FIG. 5 is an exploded view of the switch device according to a first embodiment of the invention;

FIG. 6 is the exploded view of the switch device according to a second embodiment of the invention;

FIG. 7 is a cross-sectional view of the water output device according to a first embodiment of the invention;

FIG. 8 is a cross-sectional view of the water output device according to a second embodiment of the invention;

FIG. 9 is a schematic diagram showing a first topology of the switch device according to a second embodiment of the invention;

FIG. 10 is a schematic diagram showing a second topology of the switch device according to a second embodiment of the invention;

FIG. 11 is a schematic diagram showing the supply water path in the control device and water flow body according to the invention;

FIG. 12 is a schematic diagram showing the power water path in the control device and water flow body according to the invention;

FIG. 13 is a schematic diagram showing the supply water path of the water output device according to a first embodiment of the invention;

FIG. 14 is a schematic diagram showing the power water path of the water output device according to a first embodiment of the invention;

FIG. 15 is a schematic diagram showing the supply water path of the water output device according to a second embodiment of the invention;

FIG. 16 is a schematic diagram showing the supply water path of the switch device according to a second embodiment of the invention;

FIG. 17 is a schematic diagram showing the power water path of the water output device according to a second embodiment of the invention;

FIG. 18 is a schematic diagram showing the power water path of the switch device according to a second embodiment of the invention;

FIG. 19 is a schematic diagram showing an American-standard shower apparatus exemplifying the shower apparatus according to the invention; and

FIG. 20 is a schematic diagram showing a European-standard shower apparatus exemplifying the shower apparatus according to the invention.

### DETAILED DESCRIPTION OF PREFERRED EMBODIMENTS

Next, the invention will be elaborated clearly and exhaustively with reference to the accompanying drawings. Apparently, the embodiments described herein are merely taken as being illustrative in nature but not limiting to the scope of the disclosure. Based on the embodiments disclosed herein, any embodiments derived by an artisan skilled in the art without inventive laboring should be encompassed in the scope of the disclosure.

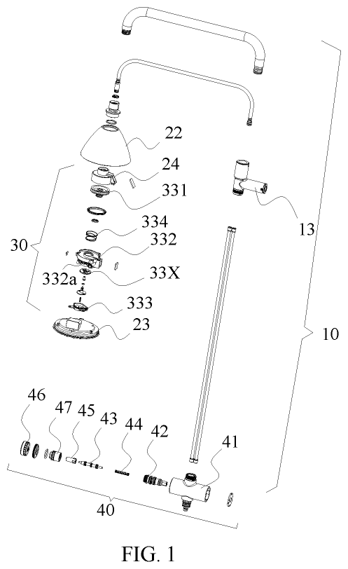

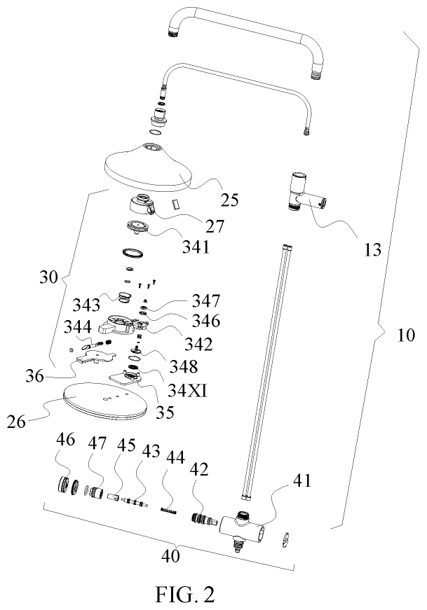

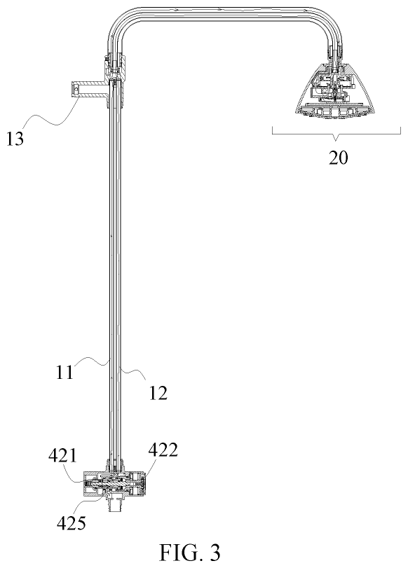

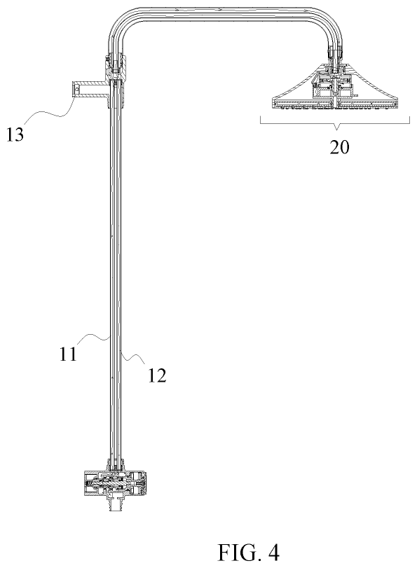

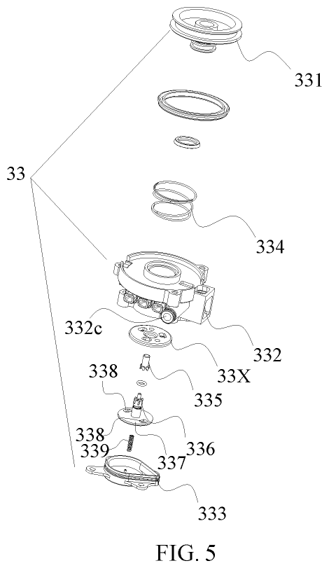

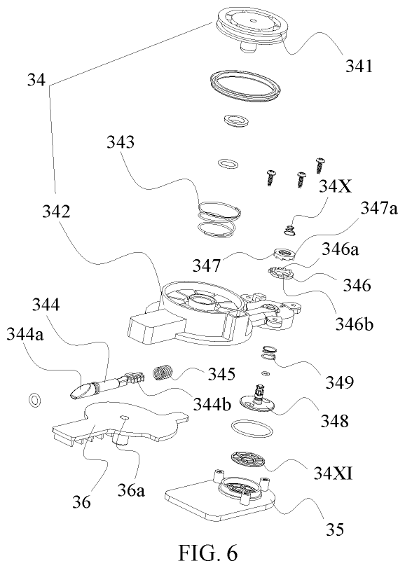

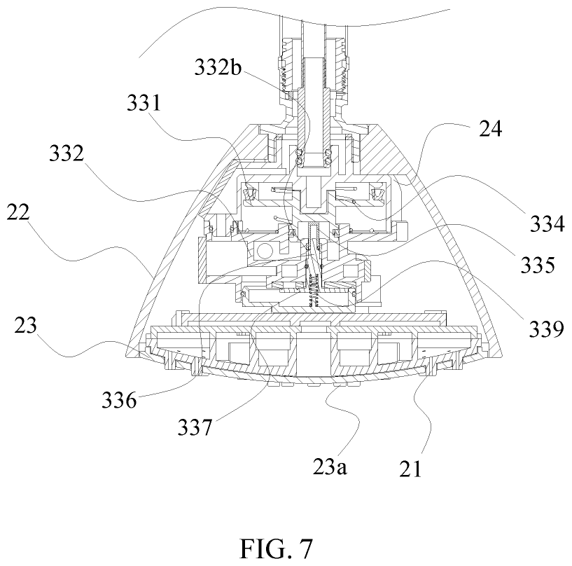

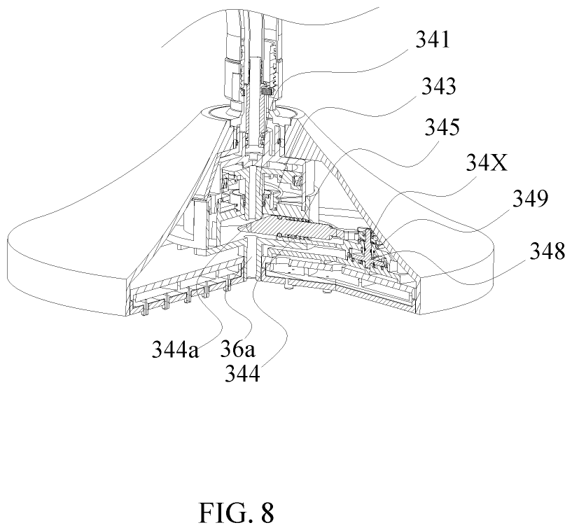

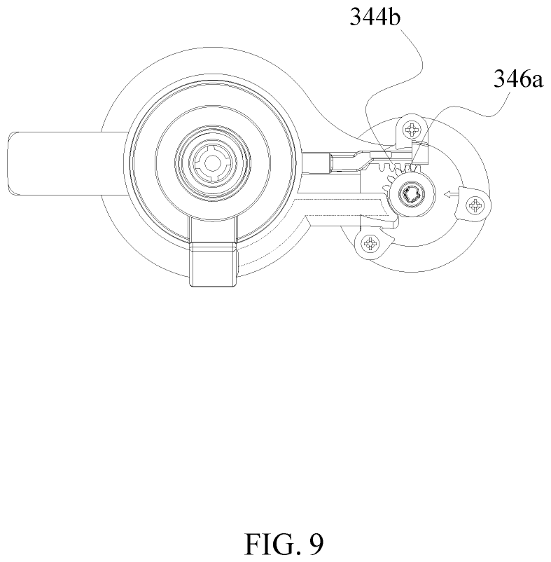

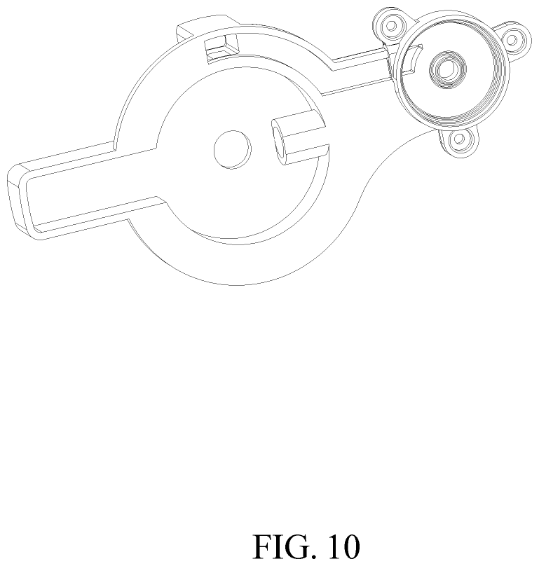

References are now made to FIGS. 1-20. A shower apparatus includes a water flow body 10. The water flow body 10 includes a water output device 20 mounted thereon. The water output device 20 is provided with a water outlet 21. The water output device 20 can provide at least two water output effects. The interior of the water flow body 10 is provided with a first water flow conduit 11 and a second water flow conduit 12. The interior of the water output device 20 is provided with a switch device 30. The switch device 30 is provided with a third water flow conduit 31 communicating with the first water flow conduit 11. The third water flow conduit 31 is also communicated with the water outlet 21. The switch device 30 further includes a fourth water flow conduit 32 communicating with the second water flow conduit 12. The switch device 30 can change the water output effect of the water outlet 21. Concretely speaking, the switch device includes a water bifurcation tray that can change the water output effect of the water outlet. The water flow body 10 is further provided with a control device 40 for controlling the water input flowing through the first water flow conduit 11 or a second water flow conduit 12. By means of the foregoing dual water paths configuration, the supply water path and the power water path can be separated from each other. In this way, these water paths will not interfere with each other during operation. Thus, the stability of the water output effect is reinforced. Above all, the design flaw existing in the conventional hydraulic switch device is overcome. This can ensure that the supply water spray and the power water spray will not interfere with each other. The concrete design flaw existing in the prior art is that the conventional hydraulically switched shower apparatus adopts the single water path design, that is, the supply water path and the power water path share the same conduit. At the instant the user opens or closes the valve of the faucet, the water pressure undergoes abrupt change and the switch device is prone to be driven to operate, such that the position of the functional water flow hole is changed and the water spray pattern is changed accordingly. The user must tune or switch the valve of the faucet many times to revive the previous water spray pattern. This is detrimental to human-machine relationship.

Furthermore, the control device 40 includes a body 41. The interior of the body 41 includes a water cutting body 42, which includes a water input conduit 425, a first water output conduit 421, and a second water output conduit 422. The first water output conduit 421 is communicated with the first water flow conduit 11. The second water output conduit 422 is communicated with the second water flow conduit 12. The interior of the water cutting body 42 is operatively connected to a water cutting shaft 43. A first spring 44 is mounted between the water cutting shaft 43 and the water cutting body 42. More concretely, the water cutting shaft 43 is operatively connected to a pressing shaft 45. The pressing shaft 45 is operatively connected to a switch 46. The interior of the body 41 is provided with a fastening assembly 47 connected to the pressing shaft 45 and the water cutting shaft 43 for the purpose of fastening. In this embodiment, the switch 46 is a button. The control function can be activated by pressing the button. However, the configuration of the switch 46 is not limited to a button. The switch 46 may be configured as a knob, toggle, or dial. The invention allows a user to press the switch 46 to change the relative position of the water cutting shaft 43 and the water cutting body 42 so as to switch the water input conduit 425 to be communicated with the first water output conduit 421 or the second water output conduit 422, thereby changing the direction of waterflow. In this way, the shower apparatus can operate under the supply water mode or the power water mode.

Furthermore, the shower apparatus further includes a wall seat assembly 13 operatively connected to a wall. The wall seat assembly 13 is used to integrally secure the shower apparatus to the wall.

Furthermore, the water flow body 10 further includes a water input member 50 having a fifth water flow conduit 51. The control device 40 is provided with a water inlet 411 communicating with the water input conduit 425. The water flows through the water input member 50 and enters the interior of the control device 40 to allow the control device 40 to bifurcate the waterflow and control the water paths. When it is desired to let the water output device 20 output water, the water input conduit 425 can be communicated with the first water output conduit 421 by changing the engaged position of the water cutting shaft 43 and the water cutting body 42. When it is desired to change the water output effect of the water outlet 21 to switch the water output function, the water input conduit 425 can be communicated with the second water output conduit 422.

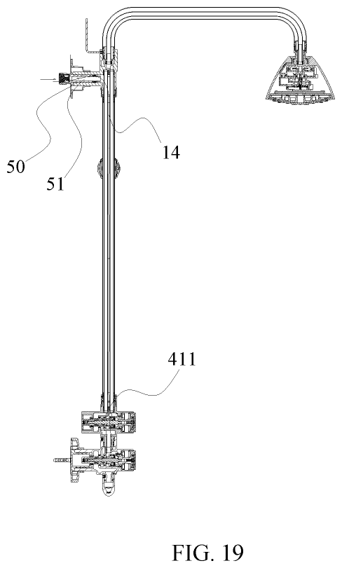

Furthermore, in the first embodiment of the invention, the water input member 50 is disposed on the upper end of the water flow body 10. The interior of the water flow body 10 is further provided with a sixth water flow conduit 14. One end of the sixth water flow conduit 14 is communicated with the fifth water flow conduit 51, and the other end of the sixth water flow conduit 14 is communicated with the water inlet 411. This configuration is set up according to American standard. Preferably, the water input member 50 can be integrated with the wall seat assembly 13, as shown in FIG. 19.

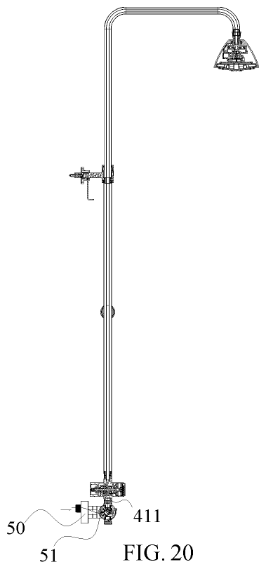

Furthermore, in a second embodiment of the invention, the water input member 50 is disposed on the lower end of the water flow body 10. The fifth water flow conduit 51 is directly communicated with the water inlet 411 on the control device 40. This configuration is set up according to European standard, as shown in FIG. 20.

Furthermore, in the first embodiment of the invention, the switch device 30 includes a first body 33 including a first thrusting member 331, a first water bifurcation body 332, and a first water sealing cover 333. The first water bifurcation body 332 includes ribs 332b with a tilted surface. The first water bifurcation body 332 is further provided with a first pressure discharging hole 332c. A second spring 334 is mounted between the first thrusting member 331 and the first water bifurcation body 332. The first thrusting member 331 is operatively connected to a first upper ratchet 335. The first upper ratchet 335 is operatively connected to a first lower ratchet 336. The first lower ratchet 336 is fixed on a first water bifurcation tray 337. The first water bifurcation tray 337 is provided with a water flow hole 338 providing at least two different functions. A third spring 339 is mounted between the first water bifurcation tray 337 and the first lower ratchet 336. The ribs 332b are used to facilitate the rotation and positioning of the first lower ratchet 336. More concretely, the first upper ratchet 335 is provided with triangular teeth, and the first lower ratchet 336 is provided with arc teeth corresponding to the triangular teeth. The invention utilizes the jacking operation of the first upper ratchet 335 and the first lower ratchet 336 to allow the first lower ratchet 336 to rotate, thereby driving the first water bifurcation tray 337 to rotate and thus changing the relative position of the water flow hole 338. This can influence the water output effect of the water output device 20 and accomplish the switching of the water output function.

Furthermore, the water output device 20 includes a first housing 22 and a first water output cover 23. The first water output cover 23 is provided with a third pressure discharging hole 23a. The third pressure discharging hole 23a is communicated with first pressure discharging hole 332c. The first housing 22 is operatively connected to the first water output cover 23. A first water input body 24 is mounted between the first housing 22 and the first water output cover 23. The first water input body 24 is operatively connected to the first water bifurcation body 332. The first thrusting member 331 and the second spring 334 are disposed inside a hollow chamber between the first water input body 24 and the first water bifurcation body 332. The first water bifurcation body 332 is provided with a water bifurcation opening 332a. The first water bifurcation body 332 is operatively connected to a first water bifurcation washer 33X. The first water bifurcation washer 33X is provided with a multiplicity of water flow openings. The first water sealing cover 333 is mounted on the first water output cover 23.

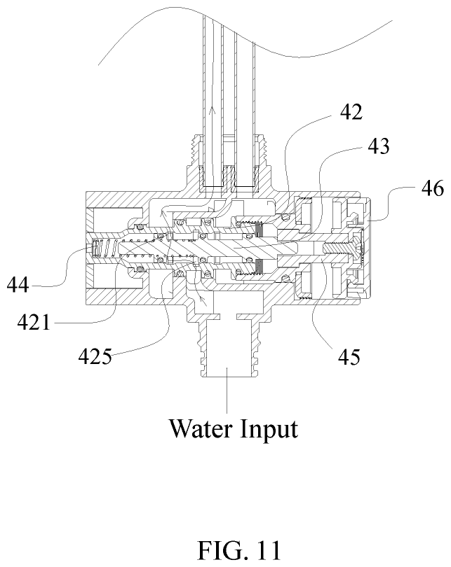

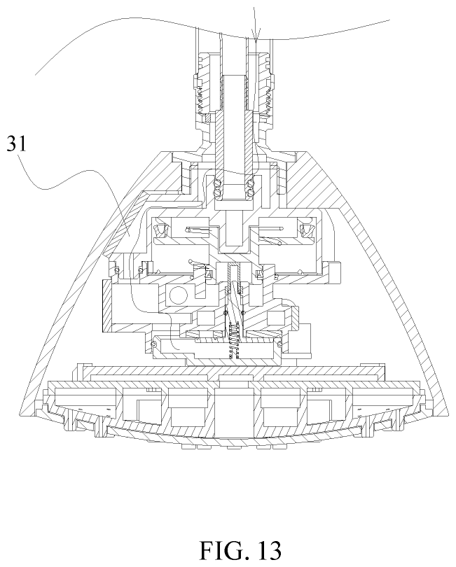

References are now made to FIGS. 11, 12, 13, and 14, which illustrate the operation under the water flow state in the first embodiment. Under the normal condition, the water output device 20 is operating in the water supply state. The water flow state of the control device 40 is illustrated in FIG. 11. Under this condition, water inputs into the control device 40, and the waterflow enters the space between the water cutting body 42 and the water cutting shaft 43 through the water input conduit 425. Under this condition, the engagement between the water cutting body 42 and the water cutting shaft 43 is described as follows. The first water output conduit 421 is opened and the second water output conduit 422 is closed. Thus, water flows through the water input conduit 425 and discharges through the first water output conduit 421, and then enters the first water flow conduit 11 and then flows to the third water flow conduit 31, and eventually discharges through the water outlet 21 so as to form water output. The water output path of the water output device 20 is illustrated in FIG. 13.

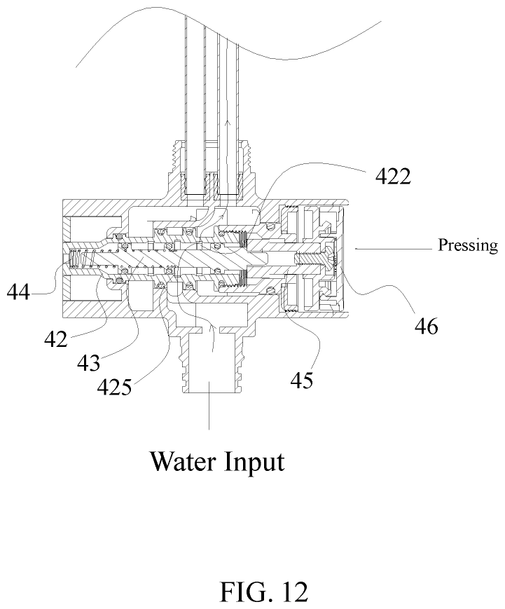

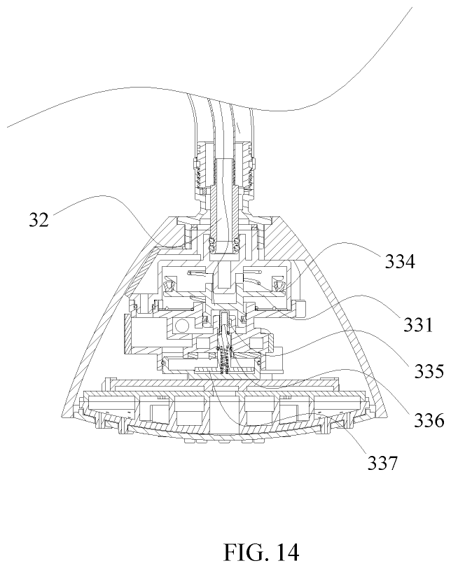

Furthermore, when the user desires to change the water output effect, the user only needs to press the switch 46 to switch the water path from supply water path to power water path. The water flow state of the control device 40 is illustrated in FIG. 12. When the switch 46 is pressed, the engaged position of the water cutting shaft 43 and the water cutting body 42 is changed. In the meantime, the first spring 44 is compressed and the first water output conduit 421 is closed, and the second water output conduit 422 is opened. The waterflow goes through the water input conduit 425 and then discharges through the second water output conduit 422, and then enters the switch device 30 to change the relative position of the first water bifurcation tray 337, thereby changing the engaged position of the functional water flow hole 338 and the water outlet 21. Thus, different water output effects can be obtained. The detailed operation is described as follows. When the waterflow discharges from the fourth water flow conduit 32 and enters the switch device 30, it will work on the first thrusting member 331. With the collaboration of the second spring 334, the first thrusting member 331 moves downwards and carries the first upper ratchet 335 to move downwards accordingly. Because the engagement between the triangular teeth of the first upper ratchet 335 and the arc teeth of the first lower ratchet 336, the first lower ratchet starts rotating and thus drives the first water bifurcation tray 337 to rotate, thereby changing the relative position of the functional water flow hole 338 and changing the water output effect accordingly. In this embodiment, the water output effects are produced under three water output states. When the user releases the switch 46, the water cutting shaft 43 is restored by means of the elastic force of the first spring 44. Under this condition, the first water output conduit 421 is opened and the second water output conduit 422 is closed, and the water output device restores the supply water path and outputs water, as shown in FIG. 14. During the switching, the water outlet does not output water, and the first pressure discharging hole 332c and the third pressure discharging hole 23a discharge water.

Furthermore, in the second embodiment of the invention the switch device 30 includes a second body 34. The second body 34 includes a second thrusting member 341 and a second water bifurcation body 342. A fourth spring 343 is mounted between the second thrusting member 341 and the second water bifurcation body 342. The second thrusting member 341 is operatively connected to a pushing rod 344. One end of the pushing rod 344 is provided with a tilted surface 344a for collaborating with the second thrusting member 341. The other end of the pushing rod is provided with a first teeth assembly 344b. The pushing rod 344 further includes a fifth spring 345 being telescoped therewith. The first teeth assembly 344b of the pushing rod 344 is operatively connected to a lower chainring 346. The lower chainring 346 includes a second teeth assembly 346a for engaging with the first teeth assembly 344b. The lower chainring 346 further includes a third teeth assembly 346b. The third teeth assembly 346b is operatively connected to a fourth teeth assembly 347a. The fourth teeth assembly 347a is mounted on an upper chainring 347. The upper chainring 347 is operatively connected to the second water bifurcation tray 348. The second water bifurcation tray 348 is provided with a sixth spring 349 being compressed for position limiting. The upper chainring 347 also includes a seventh spring 34X being compressed. More concretely, the cross-section of the third teeth assembly 346b of the lower chainring 346 is shaped as a right triangle, and the cross-section of the fourth teeth assembly 347a of the upper chainring 347 is shaped as a right triangle reversely mirrored from the cross-section of the third teethe assembly 346b. In this way, when the lower chainring 346 is rotating in a clockwise or counterclockwise direction, the upper chainring 347 can be carried to rotate along with the lower chainring 346. When lower chainring 346 is rotating in a different direction than the previous direction, the upper chainring 347 will not be carried to rotate along with the lower chainring 346. This can ensure the stability of the relative position of the second water bifurcation tray 348.

Furthermore, the water output device 20 includes a second housing 25 and a second water output cover 26. The second housing 25 is operatively connected to the second water output cover 26. A second water input body 27 is mounted between the second housing 25 and the second water output cover 26. The second water input body 27 is operatively connected to the second water bifurcation body 342. The second thrusting member 341 and the fourth spring 343 are disposed inside a hollow chamber between the second water input body 27 and the second water bifurcation body 342. The second water bifurcation tray 348 is operatively connected to a second water bifurcation washer 34XI. The second water bifurcation washer 34XI is mounted on a water bifurcation member 35. The water bifurcation member 35 is operatively connected to a sealing member 36. The sealing member 36 is provided with a second pressure discharging hole 36a.

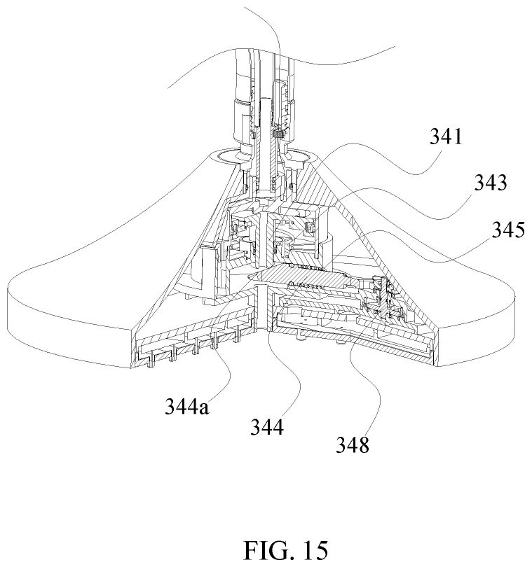

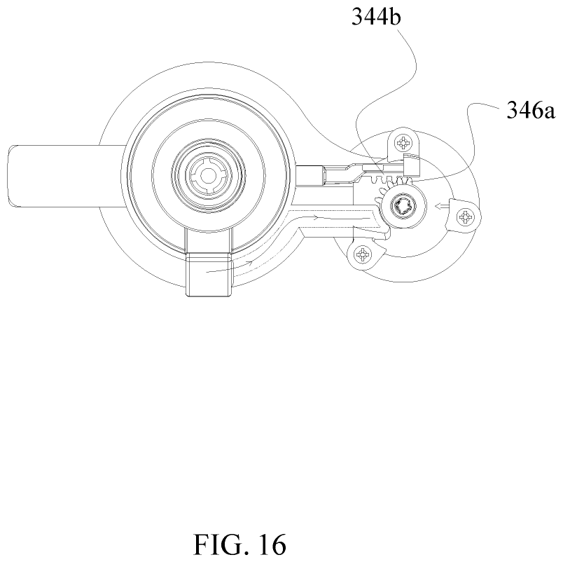

References are now made to FIGS. 11, 12, 15, 16, 17 and 18, which illustrate the operation under the water flow state in the second embodiment. Under normal condition, the water output device 20 is operating under the water supply state. The water flow state of the control device 40 is illustrated in FIG. 11. Under this condition, water flows into the control device 40, and the waterflow enters the space between the water cutting body 42 and the water cutting shaft 43 through the water input conduit 425. Under this condition, the engagement between the water cutting body 42 and the water cutting shaft 43 is described as follows. The first water output conduit 421 is opened and the second water output conduit 422 is closed. Thus, the water flows through the water input conduit 425 and discharges through the first water output conduit 421, and then enters the first water flow conduit 11 and then flows to the third water flow conduit 31, and eventually discharges through the water outlet 21 so as to form water output. The water output path of the water output device 20 is illustrated in FIG. 15 and FIG. 16.

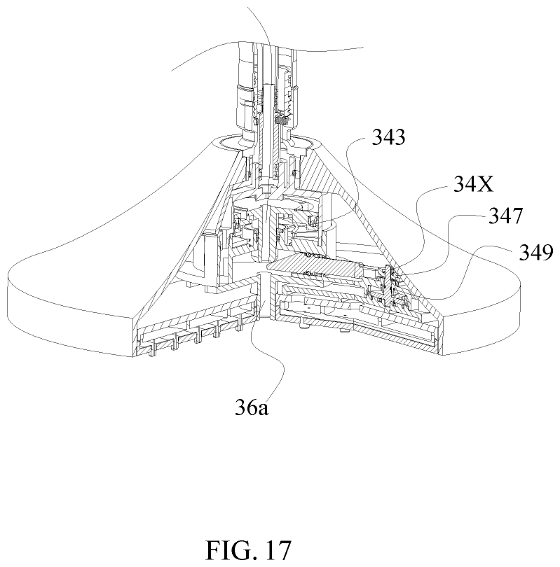

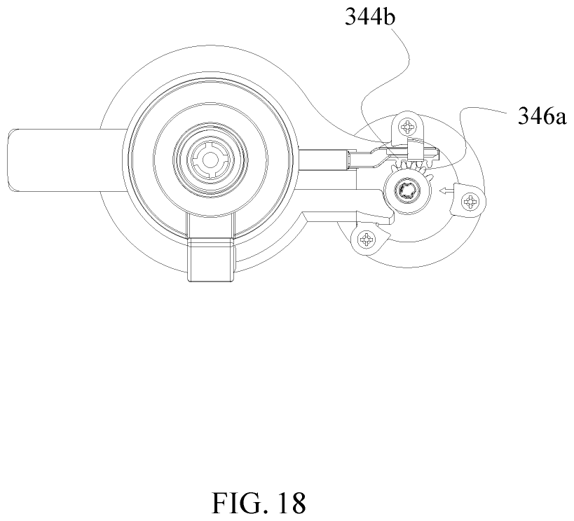

Furthermore, when the user desires to change the water output effect, the user only needs to press the switch 46 to switch the supply water path to the power water path. The water flow state of the control device 40 is illustrated in FIG. 12. When the switch 46 is pressed, the engaged position of the water cutting shaft 43 and the water cutting body 42 is changed. Under this condition, the first spring 44 is compressed, and the first water output conduit 421 is closed and the second water output conduit 422 is opened. As a result, the waterflow flows through the water input conduit 425 and then discharges through the second water output conduit 422, and then enters the fourth water flow conduit 32 and then enters the switch device 30. Therefore, the relative position of the second water bifurcation tray 348 is changed, thereby changing the engaged position of the functional water flow hole of the second water bifurcation tray 348 and the water outlet 21 to provide water output with different effects. This operating state can be understood with reference to FIG. 17 and FIG. 18. The operating principle is described as follows. When the waterflow enters the switch device 30, the waterflow works on the second thrusting member 341 to drive the second thrusting member 341 to move downwards. In the meantime, the fourth spring 343 is compressed, and the collaboration of the second thrusting member 341 and the tilted surface 344a of the pushing rod 344 drives the pushing rod 344 to move horizontally. In this embodiment, the horizontal movement of the pushing rod 344 is toward the right side. The movement of the pushing rod 344 drives the lower chainring 346 which is engaged with the pushing rod 344 to rotate through the engagement of the first teeth assembly 344b and the second teeth assembly 346a. The rotation of the lower chainring 346 drives the upper chainring 347 which is engaged with the lower chainring 346 to rotate. In the meantime, the third teeth assembly 346b of the lower chainring 346 is operatively engaged with the fourth teeth assembly 347a of the upper chainring 347 on the right-angle plane, that is, the lower chainring 346 is rotating in the clockwise direction toward the right-angle plane of the fourth teeth assembly 347a. The rotation of the upper chainring 346 drives the second water bifurcation tray 346 which is engaged with the upper chainring 346 to rotate, thereby changing the position of the functional water flow hole of the second water bifurcation tray 348. Consequently, different water output effects can be attained. More concretely, in this embodiment the second water bifurcation tray 348 is provided with three kinds of functional water flow hole, that is, three different water output effects are available for the shower apparatus of the invention. Certainly, the manufacturer can design the shower apparatus to render a variety of water output effects in accordance with market demands by changing the number of the functional water flow hole on the second water bifurcation tray 348 and proceeding with functional design. Hence, the invention is not to be precisely limited to the embodiment of providing two water output effects. The waterflow entering the switch device 30 is discharged through the second pressure discharging hole 36a after the work is done. When the user releases the switch 46, the water cutting shaft 43 is restored by means of the elastic force of the first spring 44. Under this condition, the first water output conduit 421 is opened and the second water output conduit 422 is closed, and the water output device 20 restores the supply water path to form water output, as shown in FIG. 15 and FIG. 16. Under this condition, the fourth spring 343 inside the switch device 30 is restored to drive the second thrusting member 341 to restore. The pushing rod 344 is also restored by means of the elastic force of the fifth spring 345. In practice, the pushing rod 344 is moved to the left side to restore. The restoration of the pushing rod 344 drives the lower chainring 345 to move. Under this condition, the third teeth assembly 346b of the lower chainring 346 rotates along the tilted surface of the fourth teeth assembly 347a. Under this condition, the upper chainring 347 will not be driven to rotate, and the relative position of the second water bifurcation tray 348 will not be changed. This can ensure the stability of the water output effect. During switching, the water outlet will not output water, while the second pressure discharging hole 36a discharges water.

The above descriptions only disclose a preferred embodiment of the invention. However, it is to be understood that the invention should not be limited to the accurate form or the preferred embodiments disclosed herein. The preferred embodiments stated above can not be taken to limit the scope of the invention. The invention should encompass various modifications and alterations made based on the foregoing embodiments. An artisan having ordinary skill in the art can understand the way to embody the foregoing embodiment, and the equivalent modifications which are made based on the claims are still within the scope of the invention.

What is claimed is:

1. A shower apparatus, comprising:
a water flow body having a first water flow conduit and a second water flow conduit; and
a water output device having a water outlet mounted thereon, and a switch device having a third water flow conduit communicating with the first water flow conduit and the water outlet and a fourth water flow conduit communicating with the second water flow conduit;
wherein the switch device is configured to switch between at least two water output effects, and the water flow body includes a control device for controlling water input through the first water flow conduit and the second water flow conduit.

2. The shower apparatus according to claim 1 wherein:
the control device includes a body having a water cutting body, the water cutting body includes a water input conduit, a first water output conduit, and the second water output conduit;
the first water output conduit is communicated with the first water flow conduit and the second water output conduit is communicated with the second water flow conduit;
the water cutting body is operatively connected to a water cutting shaft; and
the control device includes a first spring mounted between the water cutting body and the water cutting shaft.

3. The shower apparatus according to claim 2 wherein the water cutting shaft is operatively connected to a pressing shaft operatively connecting to a switch.

4. The shower apparatus according to claim 2 wherein:
the water flow body is provided with a water input member having a fifth water flow conduit; and
the control device is provided with a water inlet communicating with the water input conduit.

5. The shower apparatus according to claim 4 wherein the water input member is mounted on an upper end of the water flow body, and the water flow body further includes a sixth water flow conduit having one end communicating with the fifth water flow conduit and the other end communicating with the water inlet.

6. The shower apparatus according to claim 4 wherein the water input member is mounted on a lower end of the water flow body, and the fifth water flow conduit is directly communicated with the water inlet on the control device.

7. The shower apparatus according to claim 1 wherein:
the switch device includes a first body including a first thrusting member, a first water bifurcation body, and a first water sealing cover;
the first water bifurcation body includes ribs with a tilted surface and a first pressure discharging hole;
the switch device includes a second spring mounted between the first thrusting member and the first water bifurcation body, and a first water bifurcation tray;
the first thrusting member is operatively connected to a first upper ratchet, and the first upper ratchet is operatively connected to a first lower ratchet, and the first lower ratchet is fixed on the first water bifurcation tray;
the first water bifurcation tray includes a water flow holes providing at least two different functions; and
the switch device includes a third spring mounted between the first water bifurcation tray and the first lower ratchet.

8. The shower apparatus according to claim 7 wherein:
the water output device includes a first housing and a first water output cover, the first water output cover includes a third pressure discharging hole communicating with the first pressure discharging hole;
the first housing is operatively connected to the first water output cover;
a first water input body is mounted between the first housing and the first water output cover, the first water input body is operatively connected to the first water bifurcation body;
the first thrusting member and the second spring are mounted inside a hollow chamber between the first water input body and the first water bifurcation body;
the first water bifurcation body includes a water bifurcation opening and is operatively connected to a first water bifurcation washer; and
the first water sealing cover is mounted on the first water output cover.

9. The shower apparatus according to claim 1 wherein:
the switch device includes a second body having a second thrusting member and a second water bifurcation body, and a fourth spring mounted between the second thrusting member and the second water bifurcation body;
the second thrusting member is operatively connected to a pushing rod having one end provided with a tilted surface collaborating with the second thrusting member and the other end provided with a first teeth assembly;
the switch device includes a fifth spring telescoped with the pushing rod, and the first teeth assembly of the pushing rod is operatively connected to a lower chainring;
the lower chainring is provided with a second teeth assembly engaged with the first teeth assembly and a third teeth assembly operatively connected to a fourth teeth assembly;
the fourth teeth assembly is mounted on an upper chainring, the upper chainring is operatively connected to a second water bifurcation tray; and
the second water bifurcation tray is provided with a sixth spring being compressed for position limiting, and the upper chainring is provided with a seventh spring being compressed.

10. The shower apparatus according to claim 9 wherein:
the water output device includes a second housing and a second water output cover operatively connected to each other, and a second water input body mounted between the second housing and the second water output cover;
the second water input body is operatively connected to the second water bifurcation body;
the second thrusting member and the fourth spring is mounted in a hollow chamber between the second water input body and the second water bifurcation body;
the second water bifurcation tray is operatively connected to a second water bifurcation washer mounted on a water bifurcation member; and
the water bifurcation member is operatively connected to a sealing member provided with a second pressure discharging hole.
